(19) United States
(12) Patent Application Publication
(10) Pub. No.: US 2014/0188571 A1
(43) Pub. Date: Jul. 3, 2014

(54) APPARATUS AND METHOD FOR EVALUATING ENERGY SAVING BASED ON SIMULATION

(71) Applicant: ELECTRONICS AND TELECOMMUNICATIONS RESEARCH INSTITUTE, Deajeon (KR)

(72) Inventors: JINSOO HAN, Daejeon (KR); YOUN KWAE JEONG, Daejeon (KR); IL WOO LEE, Daejeon (KR)

(73) Assignee: ELECTRONICS AND TELECOMMUNICATIONS RESEARCH INSTITUTE, Daejeon (KR)

(21) Appl. No.: 14/010,979

(22) Filed: Aug. 27, 2013

(30) Foreign Application Priority Data
Dec. 27, 2012 (KR) 10-2012-0154946

(51) Int. Cl. G06Q 10/06

(52) U.S. Cl. CPC G06Q 10/06375
USPC 705/7.37

(57) ABSTRACT

An apparatus for evaluating an energy saving based on a simulation, includes: a building condition collection unit configured to collect information about a building condition; and a building energy optimization unit configured to derive an energy saving measure capable of saving the energy of the building using the building condition information. Further, the apparatus includes a simulation preprocessing unit configured to preprocess various energy-related data for executing the energy saving measure to data for a simulation; a building energy simulator configured to perform a building energy simulation using the preprocessed data; and an evaluation result display unit configured to display the amount of energy that is saved in accordance with the energy saving measure.

### CROSS-REFERENCE TO RELATED APPLICATION(S)

The present invention claims priority of Korean Patent Application No. 10-2012-0154946, filed on Dec. 27, 2012, which is incorporated herein by reference.

### FIELD OF THE INVENTION

The present invention relates to a system for building energy saving, and more particularly, to an apparatus and method for evaluating an energy saving based on a simulation, which collects a use state of building and a use state of heat sources in real-time, diagnoses whether there is no elements of energy waste to derive an optimal energy saving measure, and calculates the amount of energy that will be reduced when applying the optimal energy saving measure along with when not applying the energy saving measure to display them, to allow an energy management of the building more efficiently.

### BACKGROUND OF THE INVENTION

In general, a way to save a building energy may include a case to replace aging equipments through energy audits and reorganize energy facilities, a case to derive an energy saving measure in a final consumption stage using energy in building, and a case to suggest an optimal energy use measure of the energy facilities that suits building.

In the first case, it corresponds to an ESCO (Energy Service Company) business. The ESCO business is a system that primarily replaces aging equipments and adds new equipments, and recovers the cost of an energy saving that will be obtained as a project cost. The effect of the energy saving is mainly demonstrated from billing information through a long-term system operation. The ESCO business may be an approach of a hardware saving mainly.

In the second case, it is a case of recognizing an actual use of building and diagnosing a use state of the building in real-time, to thereby derive the best way that is able to save energy in the building at a current condition.

In a case of a system, it may be possible to operate the system for a long period of time and to calculate the amount of energy saving by comparing the amounts of current use and past use. However, if the amount of an energy saving of the building is presented to users in real time, the users are interested in and are motivated in the energy saving.

### SUMMARY OF THE INVENTION

In view of the above, the present invention provides an apparatus and method for evaluating an energy saving based on a simulation, which collects a use state of building and a use state of heat sources in real-time, diagnoses whether there is no elements of energy waste to derive an optimal energy saving measure and calculates the amount of energy that will be reduced when applying the optimal energy saving measure along with when not applying the energy saving measure to display them, to allow an energy management of the building more efficiently.

In accordance with a first aspect of the present invention, there is provided an apparatus for evaluating an energy saving based on a simulation. The apparatus includes: a building condition collection unit configured to collect information about a building condition related to energy consumption in building to be managed; a building energy optimization unit configured to derive an energy saving measure capable of saving the energy of the building using the building condition information; a simulation preprocessing unit configured to preprocess various energy-related data for executing the energy saving measure to data for a simulation; a building energy simulator configured to perform a building energy simulation using the preprocessed data; and an evaluation result display unit configured to display the amount of energy that is saved in accordance with the energy saving measure on a basis of the simulated result.

Further, the building condition information may comprise information about an energy use in the building and information about an operation state of facilities in the building.

Further, the building energy optimization unit may be configured to find out elements of energy waste in the building on a basis of the building condition information and derive the energy saving measure that settles the elements of energy waste.

Further, the evaluation result display unit may be configured to display the amount of energy that will be saved when performing the energy saving measure and the amount of energy when not performing the energy saving measure.

In accordance with a second aspect of the present invention, there is provided a method for evaluating an energy saving based on a simulation. The method includes: collecting information about a building condition related to energy consumption in building to be managed; deriving an energy saving measure capable of saving the energy of the building using the building condition information; preprocessing various energy-related data for executing the energy saving measure to data for a simulation; performing a building energy simulation using the preprocessed data; and displaying the amount of energy that is saved in accordance with the energy saving measure on a basis of the simulated result.

Further, the collecting information about a building condition may comprise collecting information about an energy use in the building and information about an operation state of facilities in the building.

Further, the deriving an energy saving measure may comprise detecting elements of energy waste in the building on a basis of the building condition information and deriving the energy saving measure that settles the elements of energy waste.

Further, the displaying the amount of energy saving may comprise displaying the amount of energy that will be saved when performing the energy saving measure and the amount of energy when not performing the energy saving measure.

In accordance with an embodiment of the present invention, it is possible to allow an energy management of building more efficiently by collecting a use state of building and a use state of heat sources in real-time, diagnosing whether there are no elements of energy waste to derive an optimal energy saving measure and calculating the amount of energy that will be reduced when applying the optimal energy saving measure along with when not applying the energy saving measure to display them.

Further, in accordance with an embodiment of the present invention, the amount of energy saving is displayed, and therefore, an administrator of the building can immediately check how much an energy optimization system of the building contributes to the energy saving and is able to experience the effect of the energy saving measure. Further, it can be quantitatively confirmed the amount of energy saving owing to the energy saving measure in individual buildings, and thus it can be mastered the effective energy saving measures in managing a building energy, which eventually results in allowing the administrator of the building to enhance the effect of energy saving of the building.

### BRIEF DESCRIPTION OF THE DRAWINGS

The above and other objects and features of the present invention will become apparent from the following description of the embodiments given in conjunction with the accompanying drawings, in which:

FIG. 1 is a detailed block diagram of an apparatus for evaluating an energy saving based on a simulation in accordance with an embodiment of the present invention;

FIG. 2 is a conceptual diagram illustrating a collection of information about an energy use in a building condition collection unit in accordance with an embodiment of the present invention;

FIG. 3 is a detailed block diagram of a simulation preprocessing unit in accordance with an embodiment of the present invention; and

FIG. 4 is a control flow diagram illustrating a process of evaluating an energy saving based on a simulation.

### DETAILED DESCRIPTION OF THE EMBODIMENTS

Hereinafter, the embodiments of the present invention will be described in detail with reference to the accompanying drawings.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

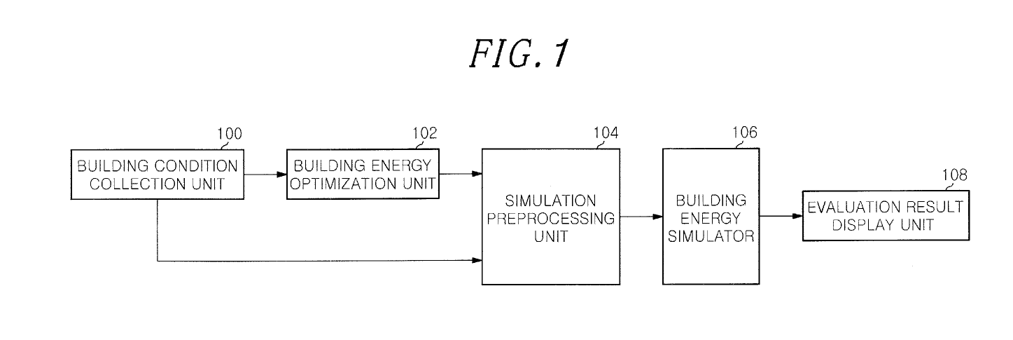

FIG. 1 is a detailed block diagram of an apparatus for evaluating an energy saving based on a simulation in accordance with an embodiment of the present invention.

Referring to FIG. 1, an apparatus for evaluating an energy saving based on a simulation includes a building condition collection unit 100 that collects information about a use state of building and/or an operating state of heat source facilities of building, a building energy optimization unit 102 for optimizing a building energy to reduce the building energy, a simulation preprocessing unit 104 for converting an energy saving measure derived from the building energy optimization unit 102 into a data format that is suitable for a simulation, a building energy simulator 106 for evaluating an energy performance of the building, and an evaluation result display unit 108 for displaying simulation results.

Hereinafter, the operation of the respective components of the apparatus for evaluating an energy saving based on a simulation will be described with reference to FIG. 1.

First, the building condition collection unit 100 collects all situations that may be happened in associated with energy consumption of the building. In this case, the building condition collection unit 100 collects state information of all facilities that are installed in the building, for example, refrigerators, boilers, air conditioners, hot and cold water pumps, cooling water pumps, cooling towers, air supply/return fans, fan coil units, dampers, and the like. The region that uses most of energy in the building is an HVAC (heating, ventilating, and air conditioning) system, and a device such as a central monitoring panel is installed at a location where machine rooms of the building to monitor the operating status of the various facilities.

In addition, in the situations of the building, there may be a space condition related to many users in the building. The space condition may include temperature, humidity, ventilation state, CO₂ concentration, an open/close state of windows and doors, state of blinds, operation state of fan coil units, lighting state of an active region of residents. Further, the space condition may include information from occupant sensors, illumination sensors, and energy meters.

That is, the building condition collection unit 100 collects the state information of the facilities of the building and condition information of residential space and uses them as basic data to determine the energy status of the entire building.

The building energy optimization unit 102, in response to the input of the data from the building condition collection unit 100, diagnoses a current state of energy use in the building to find out or detect elements of an energy waste, and derives an energy saving measure that can solve the energy waste. That is, the building energy optimization unit 102 continuously receives data representing a current state of the building from the building condition collection unit 100 and tracks a condition where energy is wasted unnecessarily in connection with information about weather, time, and season and the current condition of the building to proceed an energy optimization continuously. Further, the building energy optimization unit 102 shows the energy saving measure of the building through a component such as a screen to a building administrator, and provides information so that the building administrator can take an action for building management. Furthermore, the building energy optimization unit 102 not only presents an energy saving measure of the building, and may also be operated at a level that can be used to control the facilities and devices automatically through the system.

The simulation preprocessing unit 104 executes a process for converting the energy saving measure presented from the building energy optimization unit 102 into the data format suitable for a simulating. In this case, the building energy optimization unit 102 may propose a plan to turn off unnecessary facilities, or to remove the elements of energy consumption of residential space that are being used unnecessarily depending on the use state of the building and state of the facilities. The data proposed by the building energy optimization unit 102 cannot be used as an input to the building energy simulator 106 directly and thus needs to transform into a form suitable for the simulation in the building energy simulator 106.

Further, the simulation preprocessing unit 104 receives a current condition of the building from the building condition collection unit 100 and converts it into a form suitable for the building energy simulator 106. Accordingly, it is possible to prepare data to be compared with a case of applying the energy saving measure of the building relative to a case of maintaining the current condition of the building.

The building energy simulator 106 analyzes/evaluates an energy performance of building to be managed through an energy modeling for an actual building. In other words, the building energy simulator 106 may be a tool capable of measuring an energy performance of the actual building taking account of facilities, exterior, structure of the building, etc. and also capable of calculating the amount of an energy use of the actual building in consideration of and various parameters such as ventilation rates, lightings, solar radiation, cloudiness, external temperature and humidity, direction of the building. The building energy simulator 106 may be a self-produced simulator or a commercial or publishing tool. A tool to be used frequently may include a commercially available tool such as the EnergyPlus, ESP-r, TRNSYS and the like. In order to be used for the actual building, it is necessary to model the actual building in each simulator to construct a simulation model.

The evaluation result display unit 108 displays the amounts of energy saving when not applying the energy saving measures of the building and when applying the energy saving measure during the simulation. In this case, the evaluation result display unit 108 represents the amount of energy saving of the entire building in brief and represents the amount of energy saving of the building by zone or the amount of energy saving of the entire building for each energy source in detail.

As described above, the embodiment of the present invention provides a technique which evaluates an energy saving effect incurred by an energy saving measure of building and defined data between the respective components, but did not explicitly the location where data is actually stored. A person of ordinary skill in the art will be able to understand nevertheless even though portions of the utilization of the data are not specifically specified.

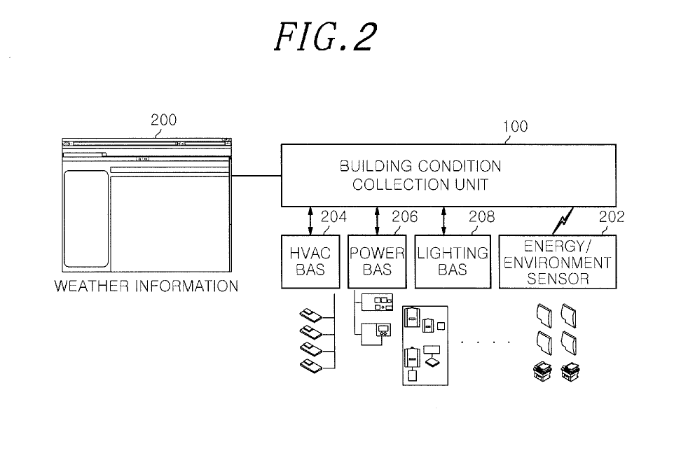

FIG. 2 is a conceptual diagram illustrating a collection of information about an energy use in the building condition collection unit.

As shown in FIG. 2, the building condition collection unit 100 is able to receive weather information for a current region from a meteorological office or a server 200 that provides weather services. The building condition collection unit 100 may also collect weather information for a site that the building is located through its own energy/environmental sensors. The building condition collection unit 100 collects the state of the facilities such as an HVAC BAS 204, a electric power BAS 206, a lighting BAS 208 and the like that consumes most of the energy of the building. Further, the building condition collection unit 100 collects information from energy/environment sensors 202 that are deployed around each space and energy metering sensors that measure the consumption of an actual energy. The Energy/environmental sensors that represent the use state of the building may include an occupant sensor, a luminance sensor, and a temperature and humidity sensor, wherein the use state of the building may include reservation information for a space such as a conference room. There is a difference in quality and quantity of information that can be collected for individual building, but it is preferable that all of the information that contributes to the energy saving of the building are collected.

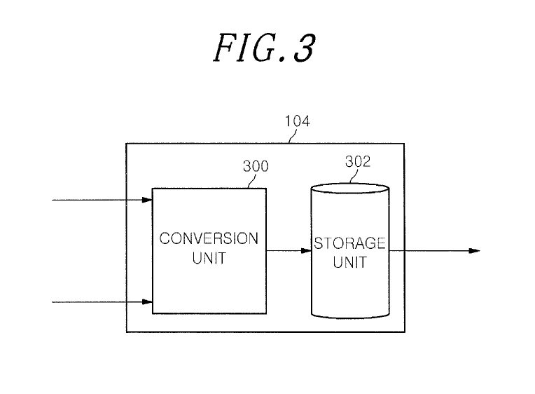

FIG. 3 is a detailed block diagram of the simulation preprocessing unit in accordance with an embodiment of the present invention.

Referring to FIG. 3, the simulation preprocessing unit 104 includes a conversion unit 300 and a storage unit 302. Since a condition of the building changes continuously, it is necessary for the simulation preprocessing unit 104 to prepare a simulation by converting the input data that change continuously.

The embodiment of the present invention allows the storage 302 to store all of the energy saving measures and the actual condition of the building that result from a lapse of time and utilizes them as the basic materials for the simulation daily, weekly or monthly in the future.

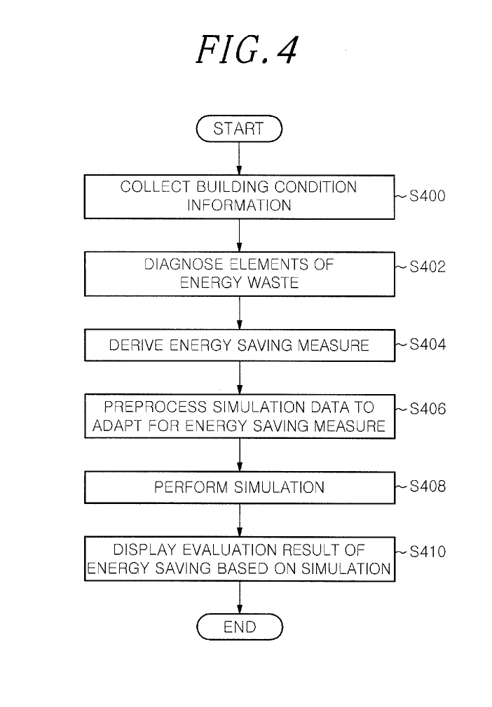

FIG. 4 is a control flow diagram of a process for deriving an energy saving measure based on a simulation and providing an evaluation result in the apparatus for evaluating an energy saving based on a simulation. Hereinafter, the embodiment of the present invention will be described with reference to FIGS. 1 to 4.

First, the building condition collection unit 100 collects condition information of the building including a current use state of the building and an operation state of the facilities of the building, in an operation S400.

The building energy optimization unit 102 finds out a condition of energy waste or elements of energy waste on a zone basis or from the viewpoint of the entire building based on the condition information of the building that is collected from the building condition collection unit 100, in an operation S402, and derives the energy saving measure to solve the condition, in an operation S404.

Such an energy saving measure can be provided through a screen in a form that can be understood by the administrator of the building. In a case where a window in any zone is open in the summer, and thus a cooling energy is wasted, an example of the energy-saving measure may be a request to close a window in the zone. Also, as another example, in a case where an outside air damper is opened to introduce an outside air among the building facilities even though a carbon dioxide concentration in an internal space is low, there occurs a waste of heating and cooling energy. At this time, the energy saving measure may be the closing of the damper.

As these examples, the building energy optimization unit 102 derives the energy saving measure that solves the condition of the energy waste in real time based on the information collected by the building condition collection unit 100. The information derived in this manner may be a primary material for the building administrator to control the facilities of the building.

Meanwhile, since the energy saving measure may not be directly used in the building energy simulator 106, it is necessary for a data conversion to match an input variable for the building energy simulator 106. Therefore, the simulation preprocessing unit 104 makes a conversion of the output data of the building energy optimization unit 102 to match the input data to the building energy simulator 106, in an operation S406. For example, an open and close of windows is to indicate a change in a ventilation rate. Therefore, it can be converted to an appropriate ventilation rate corresponding to the opening and closing of windows in the building energy simulator 106.

In addition, in the case of lighting, if the energy saving measure is to turn off the lights in part of the zone, it is checked how much the lights to be turned off becomes relative to all the lights in the zone, and it should be converted to a value suitable for the zone of the building energy simulator 106.

Thereafter, the building energy simulator 106, based on input information converted by the simulation preprocessing unit 104, performs two simulations using information based on data that is input from the building condition collection unit 100 and information based on data that is input from the building energy optimization unit 102, in an operation S408. Subsequently, the two simulation results are transferred to the evaluation result display unit 108, which in turn displays the two simulation results as the amount of energy saving when applying the energy saving measure proposed by the building energy optimization unit 102, in an operation S410. Thus, the building administrator can confirm quantitatively the effect of the energy saving measure proposed by the building energy optimization unit 102.

As described above, the apparatus for evaluating an energy saving based on a simulation of the embodiment of the present invention, unlike the case of simulating the algorithm of existing BAS EMS (Energy Management System), runs continuously in real time and thus deals with the condition of the building that changes from moment to moment. In addition, while the existing BAS EMS simulation performs the simulation weekly, monthly or daily at the time of application of various EMS functions (such as optimum start/stop control, night purge, outside air intake, lighting control, blind control, enthalpy control, etc.), the present invention shows quantitatively how much energy saving is achieved in relation to the energy saving measure that can settle a current condition of energy waste. Accordingly, the building administrator can perceive the energy saving measure more easily.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for evaluating an energy saving based on a simulation, the apparatus comprising:
a building condition collection unit configured to collect information about a building condition related to energy consumption in building to be managed;
a building energy optimization unit configured to derive an energy saving measure capable of saving the energy of the building using the building condition information;
a simulation preprocessing unit configured to preprocess various energy-related data for executing the energy saving measure to data for a simulation;
a building energy simulator configured to perform a building energy simulation using the preprocessed data; and an evaluation result display unit configured to display the amount of energy that is saved in accordance with the energy saving measure on a basis of the simulated result.

2. The apparatus of claim 1, wherein the building condition information comprises information about an energy use in the building and information about an operation state of facilities in the building.

3. The apparatus of claim 1, wherein the building energy optimization unit is configured to find out elements of energy waste in the building on a basis of the building condition information and derive the energy saving measure that settles the elements of energy waste.

4. The apparatus of claim 1, wherein the evaluation result display unit is configured to display the amount of energy that will be saved when performing the energy saving measure and the amount of energy when not performing the energy saving measure.

5. A method for evaluating an energy saving based on a simulation, the method comprising:
collecting information about a building condition related to energy consumption in building to be managed; deriving an energy saving measure capable of saving the energy of the building using the building condition information;
preprocessing various energy-related data for executing the energy saving measure to data for a simulation;
performing a building energy simulation using the preprocessed data; and
displaying the amount of energy that is saved in accordance with the energy saving measure on a basis of the simulated result.

6. The method of claim 5, wherein said collecting information about a building condition comprises collecting information about an energy use in the building and information about an operation state of facilities in the building.

7. The method of claim 5, wherein said deriving an energy saving measure comprises detecting elements of energy waste in the building on a basis of the building condition information and deriving the energy saving measure that settles the elements of energy waste.

8. The method of claim 5, wherein said displaying the amount of energy saving comprises displaying the amount of energy that will be saved when performing the energy saving measure and the amount of energy when not performing the energy saving measure.
